(19) United States
(12) Patent Application Publication
(10) Pub. No.: US 2019/0342366 A1
(43) Pub. Date: Nov. 7, 2019

(54) INFORMATION SHARING SYSTEM, INFORMATION SHARING SERVER AND INFORMATION SHARING PROGRAM

(71) Applicant: Cohcoh Co., Ltd., Nasushiobara-shi (JP)

(72) Inventor: Hiroyuki YAMASAKI, Nasushiobara-shi (JP)

(73) Assignee: Cohcoh Co., Ltd.

(21) Appl. No.: 16/393,972

(22) Filed: Apr. 25, 2019

(30) Foreign Application Priority Data
May 1, 2018 (JP) 2018-088366

(51) Int. Cl. H04L 29/08; G06F 16/958; G06F 16/955

(52) U.S. Cl. CPC H04L 67/02; G06F 16/9566; G06F 16/986

(57) ABSTRACT

In order to quickly transmit the information to the people who need the information while preventing the same information from being shared redundantly, the present invention provides an information sharing system for sharing information transmitted via an internet, the system has: a contribution unit that receives and registers an input of a contribution information including a page information identifying a web page; a display unit that processes the registered contribution information to display a browsing window that presents the information relating to the web page; and a determination unit that determines to allow or deny a registration of the inputted contribution information using a newly inputted page information and the page information included in the registered contribution information, wherein the contribution unit registers the contribution information based on a determination result of the determination unit.

### CROSS-REFERENCES TO RELATED APPLICATIONS

This patent specification is based on Japanese patent application, No. 2018-088366 filed on May 1, 2018 in the Japan Patent Office, the entire contents of which are incorporated by reference herein.

### BACKGROUND OF THE INVENTION

### 1. Field of the Invention

The present invention relates to an information sharing system for quickly sharing information transmitted via the internet.

### 2. Description of the Related Art

Various technologies are known about bulletin boards, electronic news and the like for sharing the information via the internet. For example, Patent document 1 discloses a method for updating contributed articles via the network. When the content of the contribution is updated, it is notified to a person who accessed the contribution before the content was updated.

[Patent document 1] Japanese Unexamined Patent Application Publication No. 2005-332262

### BRIEF SUMMARY OF THE INVENTION

As explained above, a large amount of information is transmitted via the internet day by day. However, the value of the information is a mixture of good and bad, and useful information is buried in useless information. Thus, it is not easy to obtain the necessary information.

In addition, novelty is particularly important for the value of the information. Even if the information is useful when it is transmitted, the information may become useless when it takes time to transmit the information. Accordingly, we need the method for quickly sharing the valuable information among the people who need it.

The present invention provides a system capable of quickly transmitting the information to the people who need it while preventing the same information from being shared redundantly.

The present invention provides an information sharing system for sharing information transmitted via an internet, comprising:
a contribution unit that receives and registers an input of a contribution information including a page information identifying a web page;
a display unit that processes the registered contribution information to display a browsing window that presents the information relating to the web page; and
a determination unit that determines to allow or deny a registration of the inputted contribution information using a newly inputted page information and the page information included in the registered contribution information, wherein
the contribution unit registers the contribution information based on a determination result of the determination unit.

As described above, since the registration of the inputted contribution information is determined by using the newly inputted page information and the page information included in the registered contribution information, the contribution of the same web page is prevented from being registered redundantly. This can reduce the risk that the useful information is buried in a large amount of contributions sharing the same content.

In a preferable embodiment of the present invention, the determination unit determines to allow the registration of the inputted contribution information when the newly inputted page information is different from the page information included in the registered contribution information.

In a preferable embodiment of the present invention, the contribution information includes a URI of the web page as the page information.

As described above, the web page can be uniquely identified by using the URI of the web page as the page information. In addition, a link to the web page can be provided on the browsing window which is displayed based on the contribution information including the page information.

In a preferable embodiment of the present invention, the determination unit determines to deny the registration of the inputted contribution information when the newly inputted page information is substantially same as the page information included in the registered contribution information.

As described above, when the page information identifying the substantially same web page has been already registered, the registration of the newly inputted contribution information is determined to be denied. Thus, the page information identifying the substantially same web page (i.e., only a part is different) is prevented from being contributed redundantly. Namely, the redundant contributions related to the same web page can be more surely prevented.

In a preferable embodiment of the present invention, the registered contribution information includes a registration date information indicating a date of the registration, and
the determination unit determines to allow or deny the registration of the inputted contribution information using the contribution information registered within a predetermined time period in the registered contribution information.

As described above, since the registration of the inputted contribution information is determined by using the contribution information registered within the predetermined time period, the contribution of the other users can be registered again when the predetermined time period has passed after the contribution. Namely, since the upper limit is specified for the time period of eliminating the other contribution information by the registered contribution information, the opportunity of sharing the information can be increased. For example, when the user follows the other user and browses the contributions of the other user, bad effects (e.g. burial of useful information) caused by the contribution of an unpopular user (i.e., a user having a few followers) can be prevented.

In a preferable embodiment of the present invention, the registration date information includes a time of the registration, and
the determination unit determines to allow or deny the registration of the inputted contribution information using the time of the registration.

As described above, since the time of the registration is included in the registration date information, whether or not each of the contribution information is registered within the predetermined time period can be judged by the time in more detail. In addition, a short period of approximately several hours to several days can be specified as the predetermined time period.

In a preferable embodiment of the present invention, the contribution information includes a category information selected from preset categories based on a content of the web page, and
the determination unit determines to allow the registration of the inputted contribution information when at least one of the page information and the category information included in a newly inputted contribution information is different from the registered contribution information.

As described above, the contribution information is registered when the category information is different even if the page information is the same. Thus, the contribution can be enabled on the same web page in a different purpose. Consequently, the sharing of the information can be urged from various viewpoints. In addition, bad effects caused when an improper category information is selected by the contributor can be prevented. Thus, the transmission of the information is not prevented by that.

The present invention provides an information sharing server for sharing information transmitted via an internet, comprising:
a contribution unit that receives and registers an input of a contribution information including a page information identifying a web page;
a display unit that processes the registered contribution information to display a browsing window that presents the information relating to the web page; and
a determination unit that determines to allow or deny a registration of the inputted contribution information using the page information included in the inputted page information and the registered contribution information, wherein
the contribution unit registers the contribution information based on a determination result of the determination unit.

The present invention provides an information sharing program for sharing information transmitted via an internet to make a computer function as:
a contribution unit that receives and registers an input of a contribution information including a page information identifying a web page;
a display unit that processes the registered contribution information to display a browsing window that presents the information relating to the web page; and
a determination unit that determines to allow or deny a registration of the inputted contribution information using the page information included in the inputted page information and the registered contribution information, wherein
the contribution unit registers the contribution information based on a determination result of the determination unit.

The present invention can provide a system capable of quickly transmitting the information to the people who need it while preventing the same information from being shared redundantly.

### BRIEF DESCRIPTION OF THE DRAWINGS

FIG. 1 is a functional block diagram of an information sharing system in an embodiment of the present invention.

FIG. 2 is a drawing showing an example of a contribution information in an embodiment of the present invention.

FIG. 3 is a flowchart showing a flow of a process of registering a contribution information in an embodiment of the present invention.

FIG. 4 is a drawing showing a display example of a new contribution window in an embodiment of the present invention.

FIG. 5 is a flowchart showing a flow of a process of determining to allow or deny the registration of the contribution information in an embodiment of the present invention.

FIG. 6 is a display example of an error of the new contribution window in an embodiment of the present invention.

FIG. 7 is a drawing showing a display example of a browsing window of the contribution in an embodiment of the present invention.

FIG. 8 is a drawing showing a display example of a ranking window of the contribution in an embodiment of the present invention.

FIG. 9 is a drawing showing a display example of a newly-arrived contribution display window in an embodiment of the present invention.

FIG. 10 is a drawing showing a display example of a user window in an embodiment of the present invention.

FIG. 11 is a drawing showing a display example of a timeline window in an embodiment of the present invention.

### DETAILED DESCRIPTION OF THE INVENTION

Hereafter, an embodiment of the present invention will be explained in detail referring to the drawings. Note that the embodiment shown below is an example of the present invention. The present invention is not limited to the embodiment shown below. Various configurations can be also adopted. For example, although the configuration, the operation and the like of the information sharing system will be explained in the present embodiment, a method, a server device, a computer program and a recording medium and the like having the same configuration can have the same functions and effects. In addition, the program can be stored in the recording medium. By using the recording medium, the program can be installed in the computer, for example. Here, the recording medium storing the program can be a non-transitory recording medium such as a CD-ROM, for example.

The present invention relates to a system for managing contributions of users about the web page to share the information. In the present embodiment, an input of a URI (Uniform Resource Identifier) of the web page is received from the users as a page information identifying the web page and a contribution information including the page information is registered. Any other arbitrary information than the URI can be used as the page information as long as the information can uniquely identify the web page.

The information sharing system of the present embodiment receives “thanks” to the contribution from the users who browse the contribution of the other users. In the present embodiment, “thanks” is used by the users who browse the contribution to express appreciation or gratitude to the contribution. The number of “thanks” is counted for each contribution. The number of “thanks” can be considered as an evaluation of the contribution from the other users. Thus, the number of “thanks” can be used as a quantitative evaluation index of the contribution. In the present embodiment, the thanks to the contribution is received, for example, by operating “thanks button” by the users via the later described browsing window.

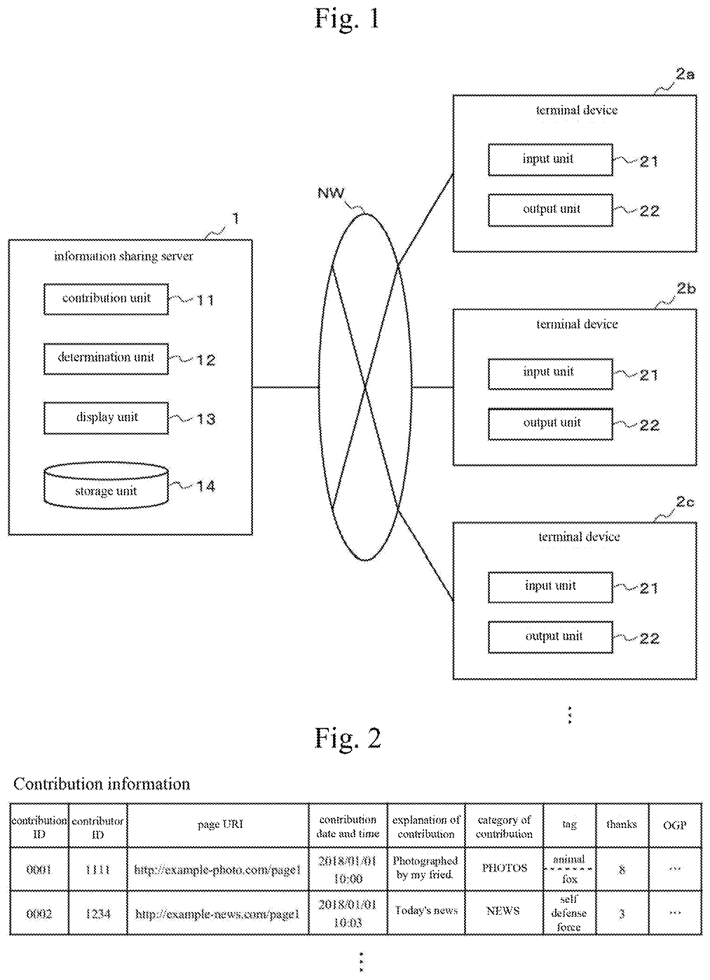

FIG. 1 is a drawing showing a functional configuration of the information sharing system in the present embodiment. As shown in FIG. 1, the information sharing system of the present embodiment is configured by an information sharing server 1 for managing the contribution information and terminal devices 2 used by the users for browsing the contributions and other information so as to be communicated with each other via a network NW. FIG. 1 shows the configuration where one information sharing server 1 and a plurality of terminal devices 2 are connected with each other via the network NW. However, the present invention is not limited to the above described configuration. For example, the function and the configuration of the information sharing server 1 can be achieved by cooperating a plurality of server devices.

For the information sharing server 1, general computer devices such as a server device having an arithmetic unit such as a CPU (Central Processing Unit), a main storage unit such as a RANI (Random Access Memory), an auxiliary storage unit such as a flash memory, a SSD (Solid State Drive) and HDD (Hard Disk Drive), and various input/output devices including a connection means for connecting to the network NW can be used. More specifically, the computer devices can be used as the information sharing server 1 of the information sharing system of the present embodiment by preliminarily storing an information sharing program for operating the information sharing server 1 as the later described various units in the auxiliary storage unit or copying the information sharing program from the recording medium or the like to the auxiliary storage unit, and extracting the information sharing program on the main storage unit to execute the calculation and control the input/output unit.

In addition, for the terminal devices 2, general computer devices having the arithmetic unit, the main storage unit, auxiliary storage unit, the connection means for connecting to the network NW and various input/output devices can be used. In the present embodiment, the configuration of using a smartphone as the terminal device 2 is exemplified. However, any other arbitrary computer devices such as a PC (Personal Computer) and a tablet terminal can be used. Specifically, the terminal device can be functioned as the terminal devices 2 of the information sharing system of the present embodiment by, for example, inputting/outputting the contribution of the information of the web page using a web browser program of the computer device. Otherwise, the computer device can be used as the terminal devices 2 of the information sharing system of the present embodiment by installing a dedicated application software for executing various input/output.

The information sharing server 1 of the present embodiment has a contribution unit 11, a determination unit 12, a display unit 13 and a storage unit 14. The contribution unit 11 receives an input of the contribution information from the user via the terminal devices 2 and registers the contribution information based on a determination result of the determination unit 12.

The determination unit 12 determines to allow or deny the registration of the inputted contribution information by comparing the page information included in the newly inputted contribution information with the page information included in the registered contribution information. In the present embodiment, the determination unit 12 determines to allow the registration of the inputted contribution information when the newly inputted page information is different from the page information included in the already registered contribution information. When the newly inputted page information is defined as a first page information and the page information included in the already registered contribution is defined as a second page information, the determination unit 12 determines to allow the registration of the inputted contribution information when the first page information is different from the second page information.

In the present embodiment, even if the both page information are not completely same, when both page information can be considered to be substantially same, the determination unit 12 can regard the both page information as being not different and determine to deny the registration of the inputted contribution information.

For example, when an anchor or a parameter is added to the URI of the page, the URI may be described by the different string of letters although it indicates the substantially same page. As a concrete example, although URI “http://example.com/page1” and URI “http://example.com/page1#ancor” identify the same page, the later URI further specifies the element in the page. Thus, the later URI is indicated by the different string of letters.

In the above described case, if the both page information are treated as different information, the contribution information including the page information indicating the substantially same page may be registered redundantly. In the present embodiment, when the web pages identified by a plurality of page information can be considered to be substantially same, the determination unit 12 judges the page information are not different (i.e., the page information are same). Thus, the above described inconvenience can be solved.

The display unit 13 processes the registered contribution information and transmits a processing result to the terminal devices 2 to display a browsing window that presents the information relating to the web page on the terminal devices 2.

The storage unit 14 stores the contribution information registered by the contribution unit 11 and user information (not illustrated). FIG. 2 is a drawing showing an example of the contribution information registered in the storage unit 14 in the present embodiment. The contribution information of the present embodiment includes a contribution ID, a contributor ID for identifying the user (i.e., contributor), a page information (page URI), the information of a registration date (contribution date and time) indicating the date and time when the contribution information is registered, the information of an explanation of contribution, the information of a category of contribution, the information of a tag, the information of the number of the thanks for the contribution, and the information of an OGP for displaying the information of the web page on the later described browsing window.

In the present embodiment, the user should log in the system after a user registration in order to input the contribution information. Consequently, the contributor of each contribution can be identified, and the user can browse the contribution of the specific contributor via the later described user window or timeline window, for example.

In the present embodiment, the number of the thanks to each contribution is stored as the contribution information. However, the record of the thanks including the date and time when the thanks is received, the contribution ID of the target contribution and a user ID of the user who gives the thanks can be also stored. As described above, by storing the date and time when the thanks is received, the number of the thanks received for each contribution can be calculated by specifying an accumulation period.

The terminal devices 2 has an input unit 21 and an output unit 22. In the present embodiment, the terminal devices 2 has a touch panel display which functions both as the input unit 21 and the output unit 22. In addition, the terminal devices 2 can further have a microphone and a speaker so that sounds can be inputted and outputted, for example.

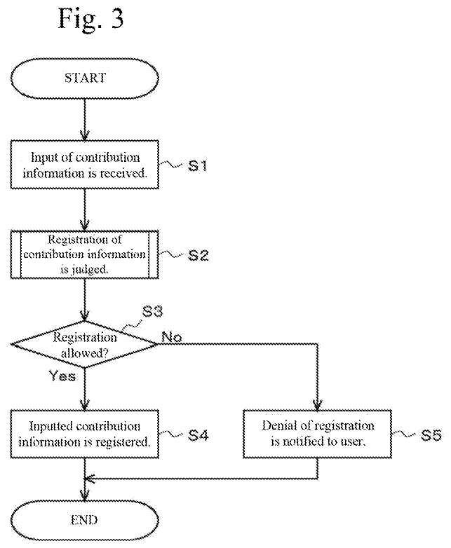

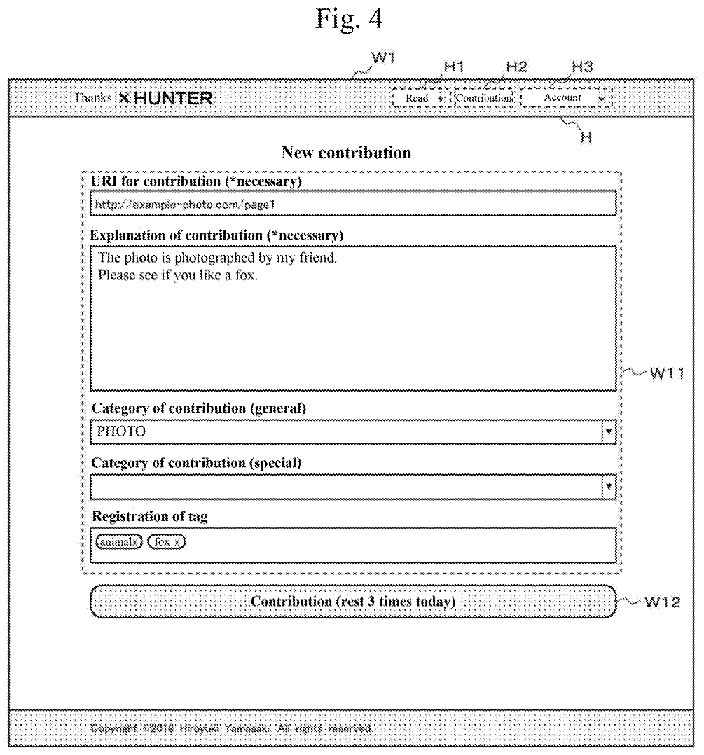

FIG. 3 is a flowchart showing a flow of the process of registering the contribution information in the present embodiment. First, in Step S1, the contribution unit 11 receives an input of the contribution information from the user via the new contribution window displayed on the terminal devices 2. FIG. 4 is a display example of the new contribution window. A new contribution window W1 has a contribution information input area W11 and a contribution button W12.

The user inputs the contribution information including the URI (page information) to which the contribution is targeted via the contribution information input area W11. In addition, inputs of an explanation of contribution, a category of contribution and a tag accompanied with the contribution are received in the present embodiment. As for the category of contribution, the user selects a category from preset categories. As for the tag, the user inputs the words serving as a keyword relating to the contribution. The number of the words to be inputted can be zero, one or more than one. As for the tag, options can be preliminarily specified and selected by the user, or words can be freely inputted by the user.

When the user operates the contribution button W12, the inputted contribution information is transmitted to the information sharing server 1 and the process proceeds to Step S2. In Step S2, the determination unit 12 determines to allow or deny the registration of the inputted contribution information.

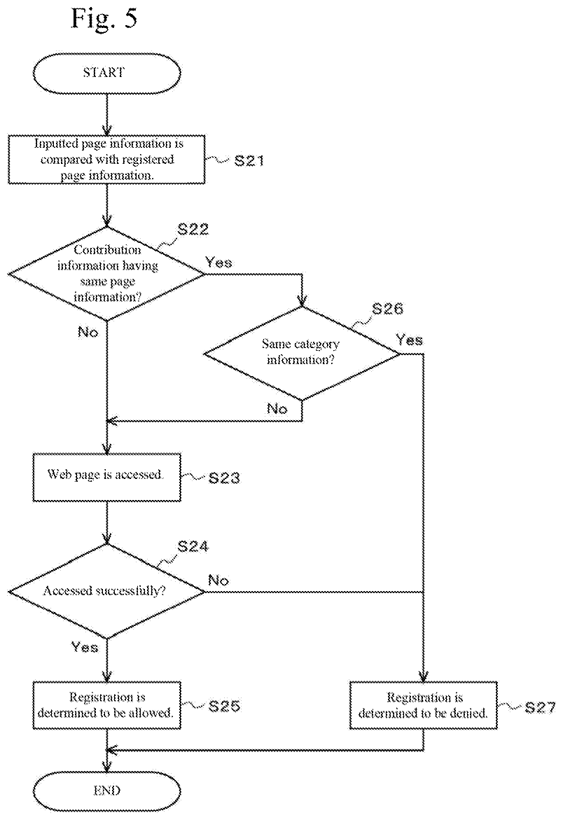

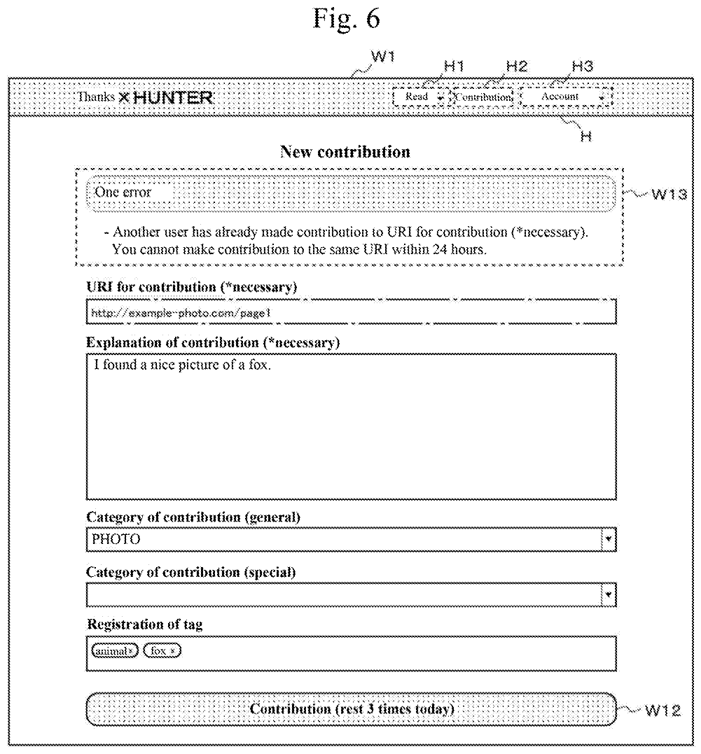

FIG. 5 is a flowchart showing a flow of a process of determining to allow or deny the registration of the contribution information determined by the determination unit 12. First, in Step S21, the newly inputted page information is compared with the page information included in the contribution information registered in the storage unit 14 to check whether or not the both page information are same. In the present embodiment, as described above, when the page information of the contribution information inputted in Step S1 is considered to be substantially same as the registered page information, the both page information are judged to be the same. However, the present invention is not limited to the above described configuration. It is also possible to determine the both page information are the same only when the newly inputted page information is completely same as the registered page information.

In the present embodiment, based on the registration date information of the registered contribution information, whether or not the both page information are different is judged for the contribution information registered within the predetermined time period. In the present embodiment, the time of the registration (contribution date and time) is stored in addition to the registration date. The contribution information registered within the predetermined time period is extracted based on the time of the registration. In the present embodiment, the predetermined time period is set to 24 hours. Thus, the judgement is performed for the contribution information registered within 24 hours before the input is received in Step S1. Namely, even when the contribution information including the page information same as the newly inputted page information is registered, the registered page information is not compared with the newly inputted page information if the predetermined time period has passed after the contribution information is registered.

However, the present invention is not limited to the above described configuration. For example, it is also possible to determine to allow or deny the registration by judging whether or not the page information is different for all of the registered contribution information and further judging whether or not the registration date (contribution date and time) of the contribution information is within the predetermined time period when the contribution information including the same page information as the newly inputted page information is registered.

In the present embodiment, the contribution made by the same user to the same URI is not accepted regardless of the time after the contribution is registered. However, it is also possible to accept the contribution of the same user again as well as other users for the same URI after the predetermined time period has passed.

As described above, since the contribution can be made by other users again if the predetermined time period has passed after the page information is registered, more popular users or users capable of explaining the contribution easier can make the contribution to the same page. Thus, it is expected that a risk of burial of useful information caused by the unpopularity of the contributor or other reasons can be reduced.

For example, in the present embodiment, the user can follow the other users and check the contributions of the other users in the later described timeline window. However, the contribution made by the user who has a few followers may not be browsed by many users. Even in such a case, the other users can make the contribution after the predetermined time period (24 hours in the present embodiment) has passed. Thus, if the contribution is made again by the user who has more followers, it is expected that burial of useful information can be prevented.

In Step S21, if the contribution information including the page information same as the newly inputted page information is registered (Yes in Step S22), the process proceeds to Step S26. In Step S26, in the registered contribution information including the page information same as the newly inputted page information, the determination unit 12 judges whether or not the category information is same as the category information inputted in Step S1 of FIG. 3. If the category information is also same, the process proceeds to Step S27. The registration is determined to be denied and the process is finished.

If the contribution information including the page information same as the newly inputted page information is not registered in Step S22 within a predetermined time period or if the category information is different in Step S26, the process proceeds to Step S23.

In Step S23, the web page is accessed based on the inputted URI (page information). Here, when the web page is accessed successfully (Yes in Step S24), the process proceeds to Step S25. In Step S25, the information of the image and explanation of OGP (Open Graph Protocol) set in the web page is obtained for displaying the information of the web page on the later described browsing window and the registration of the newly inputted contribution information is determined to be allowed.

However, the access to the web page in Step S23 to Step S24 and the judgement of the category information in Step S26 are not necessary for the present invention. Thus, they can be arbitrarily omitted. For example, Step S26 can be omitted. In such a case, the determination unit 12 only judges whether or not the contribution information including the page information same as the newly inputted page information is registered.

In the above explanation, whether or not the category information is different is judged in the Step S26 when the contribution information including the same page information as the newly inputted page information is registered. However, the order of the processes of the judgement can be arbitrarily changed. For example, it is also possible to judge whether or not the page information is different for the contribution information including the same category information as the newly inputted category information in Step S21.

When the judgement in Step S2 is finished as explained above, the process returns to FIG. 3 and proceeds to Step S3. When the registration of the inputted contribution information is allowed (Yes in Step S3), the process proceeds to Step S4 of FIG. 3. The inputted contribution information is registered on the storage unit 14 and the process is finished. In the present embodiment, the information of the OGP and the current time are respectively obtained in Step S25 and Step S4 and the contribution information including the information of the OGP and the contribution date/time is created and registered based on the obtained information. When the registration is denied (No in Step S3), the process proceeds to Step S5.

In Step S5, the display unit 13 processes to display error contents and notify them to the user via the new contribution window W1. FIG. 6 is a display example of the error in the new contribution window W1. As shown in FIG. 6, the new contribution window W1 displayed in Step S5 has an error display area W13. FIG. 6 shows the display example of the case when the contribution information is registered as shown in FIG. 4 and then another user inputs the same page information and the contribution button W12 is operated. The error display area W13 displays that the contribution has already made by the other user on the page information inputted by the user and the contribution cannot be made on the same page information within the predetermined time period (24 hours in this example). In the present embodiment, the item with the error (“URI for contribution” in FIG. 4) is displayed to be distinguishable from other items. Thus, the user can easily recognize the error contents.

Note that the number of the contribution of each user can be limited. In the present embodiment, the contribution of each user is limited to three times per day at the maximum. As described above, since the upper limit of the number of the contribution is determined, the user makes the contribution after the user examines the content of the contribution carefully. Thus, it is expected that the quality of the content of the contribution is improved.

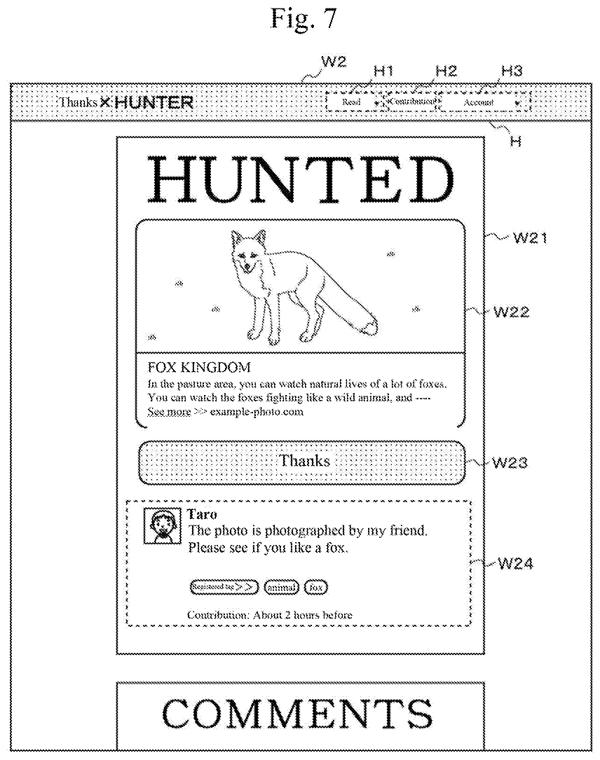

When the contribution information inputted in the process of FIG. 3 is registered, the display unit 13 processes to display the registered contribution information and the browsing window of the contribution is displayed on the terminal devices 2. FIG. 7 is a drawing showing a display example of the browsing window. As shown in FIG. 7, a browsing window W2 has a contribution display area W21. The contribution display area W21 includes a page information display area W22, a thanks button 23 and an explanation display area W24.

The page information display area W22 displays the information of the web page identified by the page information. In the present embodiment, the information is displayed based on the information obtained by accessing the web page identified by the inputted URI as the page information. Specifically, the image and explanation of OGP set in the web page and obtained in Step S25 of FIG. 5 are displayed. In the present embodiment, when the user clicks the image part or “See more” part of the page information display area W22, the screen can be moved to the web page identified by the page information.

In the present embodiment, the information of the OGP obtained in Step S25 of FIG. 2 is stored in linkage with each contribution and the page information display area W22 is displayed on the terminal devices 2 by processing the stored information of the OGP by the display unit 13. However, the present invention is not limited to the above described configuration. For example, it is possible to access the web page based on the page information included in the contribution information each time when processing to display the browsing window W2 to obtain the information of the OGP and display the page information display area W22.

When the thanks button 23 is clicked, the thanks is received for the corresponding contribution. In the present embodiment, the contribution information registered in the storage unit 14 includes the number of the thanks received for the contribution. When the thanks is received, the number of the thanks is added in the contribution information. In the present embodiment, the thanks button 23 is displayed and operable when the users other than the contributor of the contribution information are logged in. The users who are not logged in and the contributor himself/herself cannot operate the thanks button 23 with respect to the contribution.

Note that the number of times of clicking “thanks” for each user can be limited. In the present embodiment, the number of times is limited to three times per day at the maximum. As described above, since the number of times of clicking “thanks” for each user is limited, the value of one thanks can be increased. Thus, it is expected that the reliability as the evaluation index of the contribution can be increased.

The explanation display area W24 displays the explanation and the like inputted by the contributor based on the information of the explanation and the like of the contribution included in the contribution information.

The display displayed in the information sharing system of the present embodiment has a header area H which is commonly displayed in all windows. The header area H has a contribution browsing button H1 (“Read” in the figure), a new contribution button H2 (“Contribution” in the figure), and an account button H3 (“Account” in the figure). When the new contribution button H2 is selected, the new contribution window W1 is displayed and a reception of new contribution shown in FIG. 3 is started.

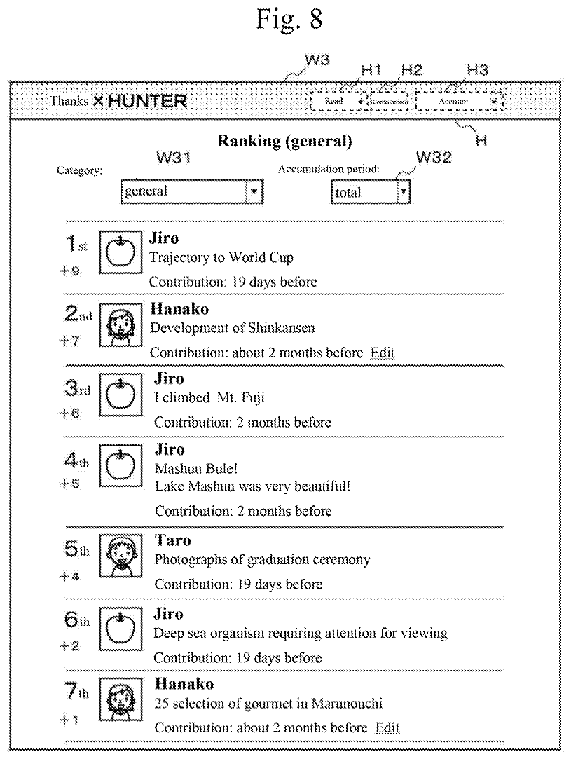

When the contribution browsing button H1 is selected by the user, options of the browsing method of the contribution are displayed to receive the selection of the user. FIG. 8 is a drawing showing a display example of a ranking window W3 displayed when the browsing of a contribution ranking is selected. In the ranking window W3, the registered contributions are displayed in the descending order of the number of the thanks. In the present embodiment, the ranking, the number of the thanks, the contributor, the explanation of the contribution and the approximate date of the contribution are displayed for each contribution.

In the present embodiment, the ranking window W3 has a category selection area W31 and an accumulation period selection area W32. The user can check the ranking of the desired category by selecting the preliminarily set options of the category and the accumulation period. In the present embodiment, a link for editing the contribution is displayed for the contribution of the currently logged-in user. The contribution can be edited by clicking the letters of “Edit.” The example of FIG. 8 shows the ranking window W3 displayed when the user having the name of “Hanako” logs in. The same applies to the later described newly-arrived contribution display window and timeline window.

In the present embodiment, in addition to the ranking for each contribution, the ranking window (not illustrated) of the number of the thanks for each user can be also selected as the browsing method. The number of the thanks for each user can be a sum of the number of the thanks to one or more contribution information inputted by each user. The ranking and the number of the thanks can be displayed for each user.

In the present embodiment, the contribution information includes the total number of the thanks received for the contribution and the ranking window is displayed based on this. However, the process of displaying the ranking window can be arbitrarily changed. For example, the ranking window W3 for each contribution and the ranking window for each user can be displayed on the terminal devices 2 by storing the category corresponding to each contribution and the ranking information of the number of various thanks corresponding to the accumulation period, updating them at any time, and processing the ranking information by the display unit 13 to transmit a processing result and display it. In addition, when the storage unit 14 stores the record of the thanks, it is possible to refer to the record of the thanks, calculate the number of the thanks and process to display the processing result each time when receiving a display request via the terminal devices 2.

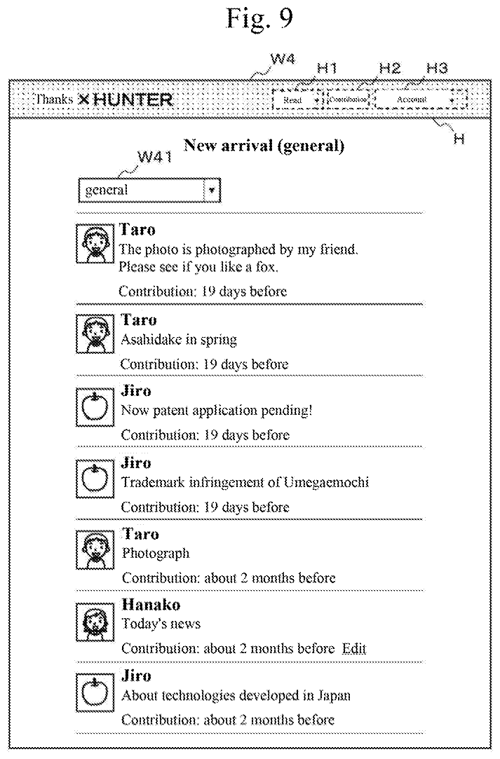

In addition, when the browsing of new contribution is selected as the browsing method, a newly-arrived contribution display window W4 shown in FIG. 9 is displayed. In the newly-arrived contribution display window W4, the registered contributions are displayed from newest to oldest. In the present embodiment, the contributor, the explanation of the contribution and the approximate date of the contribution are displayed for each contribution. Same as the ranking window W3, the newly-arrived contribution display window W4 has a category selection area 41. The user can browse newly arrived contribution by selecting the desired category.

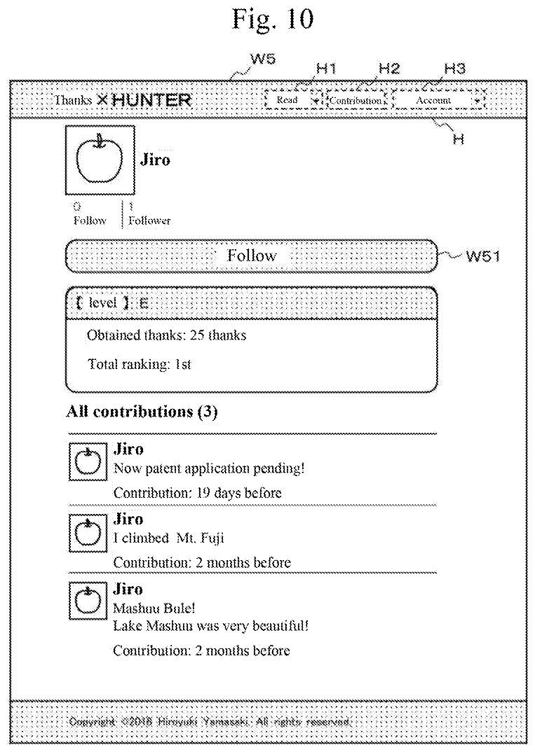

In the present embodiment, when a user name of the contribution is clicked in the ranking window W3, the newly-arrived contribution display window W4 and the later described timeline window and the like, a user window capable of checking all contributions of the corresponding user is displayed. FIG. 10 is a drawing showing a display example of a user window W5. As shown in FIG. 10, the user window of the present embodiment has a follow button W51 (“Follow” in FIG. 10).

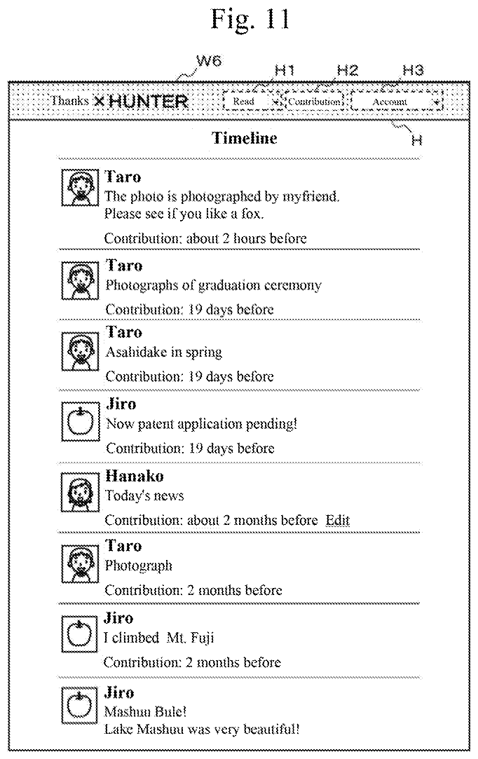

When the user “Follow” the other users, the user can check the newly arrived contributions of the other users in the timeline window. FIG. 11 is a drawing showing a display example of a timeline window W6 the present embodiment. In the timeline window W6, the contributions of the currently logged-in user and the contributions of the other users followed by the currently logged-in user are displayed from newest to oldest. The user can display the timeline window W6 by selecting the account button H3 in the header area H to browse the contributions by the timeline.

As explained above, when the information sharing system of the present embodiment is used, only one contribution information is registered for one page information. Thus, the same information is prevented from being shared redundantly. It is expected that burial of useful information can be avoided.

In addition, since “thanks” is received for the contribution from the users other than the contributor, the users can judge the value of the contribution by the number of “thanks.” Furthermore, since only one contribution is shared for one page information, the contributor who rapidly shares useful information necessarily obtains many “thanks.” Thus, incentives can be given to the contributor who make the contribution first. Consequently, it is expected that the information is quickly shared to the people who need the information.

In addition, the contribution is received again with respect to the same page information when the predetermined time period has passed after the contribution information is registered. Thus, it is expected that a risk of burial of useful information caused by the unpopularity or the lack of the ability of the explanation of the contributor can be reduced.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

### Description of the Reference Numerals

1: information sharing server, 11: contribution unit, 12: determination unit, 13: display unit, 14: storage unit, 2: terminal device, 21: input unit, 22: output unit, NW: network, W1: new contribution window, W11: contribution information input area, W12: contribution button, W13: error display area, W2: browsing window, W21: contribution display area, W22: page information display area, W23: thanks button, W24: explanation display area, W3: ranking window, W31: category selection area, W32: accumulation period selection area, W4: newly-arrived contribution display window, W41: category selection area, W5: user window, W51: follow button, W6: timeline window, H: header area, H1: contribution browsing button, H2: new contribution button, H3: account button

What is claimed is:

1. An information sharing system for sharing information transmitted via an internet, comprising:
a contribution unit that receives and registers an input of a contribution information including a page information identifying a web page;
a display unit that processes the registered contribution information to display a browsing window that presents the information relating to the web page; and
a determination unit that determines to allow or deny a registration of the inputted contribution information using a newly inputted page information and the page information included in the registered contribution information, wherein
the contribution unit registers the contribution information based on a determination result of the determination unit.

2. The information sharing system according to claim 1, wherein
the determination unit determines to allow the registration of the inputted contribution information when the newly inputted page information is different from the page information included in the registered contribution information.

3. The information sharing system according to claim 1, wherein
the contribution information includes a URI of the web page as the page information.

4. The information sharing system according to claim 1, wherein
the determination unit determines to deny the registration of the inputted contribution information when the newly inputted page information is substantially same as the page information included in the registered contribution information.

5. The information sharing system according to claim 1, wherein
the registered contribution information includes a registration date information indicating a date of the registration, and
the determination unit determines to allow or deny the registration of the inputted contribution information using the contribution information registered within a predetermined time period in the registered contribution information.

6. The information sharing system according to claim 5, wherein
the registration date information includes a time of the registration, and
the determination unit determines to allow or deny the registration of the inputted contribution information using the time of the registration.

7. The information sharing system according to claim 1, wherein
the contribution information includes a category information selected from preset categories based on a content of the web page, and
the determination unit determines to allow the registration of the inputted contribution information when at least one of the page information and the category information included in a newly inputted contribution information is different from the registered contribution information.

8. An information sharing server for sharing information transmitted via an internet, comprising:
a contribution unit that receives and registers an input of a contribution information including a page information identifying a web page;
a display unit that processes the registered contribution information to display a browsing window that presents the information relating to the web page; and
a determination unit that determines to allow or deny a registration of the inputted contribution information using the page information included in the inputted page information and the registered contribution information, wherein
the contribution unit registers the contribution information based on a determination result of the determination unit.

9. An information sharing program for sharing information transmitted via an internet to make a computer function as:
a contribution unit that receives and registers an input of a contribution information including a page information identifying a web page;
a display unit that processes the registered contribution information to display a browsing window that presents the information relating to the web page; and
a determination unit that determines to allow or deny a registration of the inputted contribution information using the page information included in the inputted page information and the registered contribution information, wherein
the contribution unit registers the contribution information based on a determination result of the determination unit.
